(19) United States
(12) Patent Application Publication
(10) Pub. No.: US 2023/0118631 A1
(43) Pub. Date: Apr. 20, 2023

(54) SYSTEM AND METHOD FOR GENERATION OF AN INTERFACE FOR UPLOAD AND REMOTE ACCEPTANCE OF A DATA FILE

(71) Applicant: BANK OF AMERICA CORPORATION, Charlotte, NC (US)

(72) Inventors: Lauren Marie Steinkerchner, Charlotte, NC (US); Bryan Slowakiewicz, Langhorne, PA (US); Netaji Basa, Monmouth Junction, NJ (US); Todd Edward Ratts, Lake George, CO (US); Pramod Bhadravathi Srinivasa, Bear, DE (US); Kerri Theresa Crawford, Eatontown, NJ (US)

(73) Assignee: BANK OF AMERICA CORPORATION, Charlotte, NC (US)

(21) Appl. No.: 17/965,724

(22) Filed: Oct. 13, 2022

Related U.S. Application Data
(60) Provisional application No. 63/255,544, filed on Oct. 14, 2021.

(51) Int. Cl. G06Q 20/04; G06V 30/42; G06Q 20/32

(52) U.S. Cl. CPC G06Q 20/042; G06V 30/42; G06Q 20/3221

(57) ABSTRACT

Systems, computer program products, and methods are described herein for the generation of an interface for upload and remote acceptance of a data file. The present invention may be configured to receive a request from a user to transfer resources associated with a document and certain user information from the user device. The document and/or the user may be associated with a supporting document. The present invention may be further configured to generate an interface comprising a triggered prompt for resource information, a triggered prompt for one or more data files containing the document, and a triggered prompt for one or more data files containing the supporting document. The present invention may be further configured to generate a request folder associated with the request. The request folder may contain the resource information, user information, the data files associated containing the document, and the data files containing the supporting document.

### CROSS-REFERENCE TO RELATED APPLICATIONS

This application is a U.S. Non-Provisional patent application claiming priority to U.S. Provisional Patent Application No. 63/255,544 filed Oct. 14, 2021 titled SYSTEM AND METHOD FOR GENERATION OF AN INTERFACE FOR UPLOAD AND REMOTE ACCEPTANCE OF A DATA FILE, the contents of which are hereby incorporated by reference in its entirety.

### FIELD OF THE INVENTION

The present invention embraces an electronic system for generating an interface for upload and remote acceptance of a data file.

### BACKGROUND

Mobile devices, such as smart phones, tablets, laptops, and other devices, enable users to share files with other users and/or entities. These devices are often equipped with the ability to generate and/or store different types of data files, as well as the ability to transfer those data files using mobile data and internet capabilities. Thus, there is a need for an interface for uploading and remotely accepting these data files.

### SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for generation of an interface for upload and remote acceptance of a data file. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving, from a computing device of a user, a request to transfer resources associated with a document into an account, wherein the account is associated with specific requirements, thresholds, or conditions. The system may then transmit a prompt via a display of the computing device of the user comprising a request for an image of the document and a request for a contribution type associated with the document. In some embodiments, the prompt comprising the request for the image of the document further causes the computing device of the user to open an image capturing device of the computing device of the user. Additionally or alternatively, in some embodiments, the prompt comprising the request for the contribution type associated with the document comprises a display of selectable available financial accounts, including the account, into which the resources may be allocated, and information and disclaimers regarding each of the available financial accounts.

The system may then receive, from the computing device of the user, the image of the document. Next, the system may extract, via optical character recognition processes, document data from the image of the document. In some embodiments, the document data comprises a payor name, a payee name, a payor account number, payor account routing number information, payor entity information associated with the specific requirements, thresholds, or conditions of the account, a document execution date, an amount of resources associated with the document, payee signature information, or payee deposit designations or indications (e.g., hand-written indication of intention to deposit resources of the document into the account).

In some embodiments, the system may then transmit a prompt via the display of the computing device of the user comprising a request for a supplemental document related to the document and the account. The prompt comprising the request for the image of the supplemental document may further cause the computing device of the user to open an image capturing device of the computing device of the user. Additionally or alternatively, the prompt comprising the request for the image of the supplemental document may include a textual message comprising a statement of the specific requirements, thresholds, or conditions associated with the account.

The system may then receive, from the computing device of the user, the image of the supplemental document. The system can then extract, via optical character recognition processes, supplemental document data from the image of the document. In some such embodiments, the supplemental document data comprises information associated with the user's eligibility to deposit resources into the account (including user metrics associated with the specific requirements, thresholds, or conditions associated with the account), information associated with the qualification of the resources associated with the document to be deposited into the account, or information associated with the payor's registration with a program associated with the account.

In response to determining that the extracted supplemental document data meets the specific requirements, thresholds, or conditions of the account, the system may transfer the resources associated with the document into the account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for generating an interface for upload and remote acceptance of a data file, in accordance with an embodiment of the invention;

FIG. 2 illustrates a process flow for generating an interface for upload and remote acceptance of a data file, in accordance with an embodiment of the invention;

FIG. 3 illustrates an exemplary interface for upload and remote acceptance of a data file, in accordance with an embodiment of the invention; and

FIG. 4 illustrates a process flow for generating an interface for upload and remote acceptance of a data file, in accordance with an embodiment of the invention;

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As noted, the system may be configured to generate an interface for upload and remote acceptance of a data file. During a mobile interaction between a user and another user or an entity, a user may initiate a deposit of a financial document. The financial document may be a check, deposit slip, or certificate. The mobile interaction may require additional documents, or supporting documents, to complete the interaction or to accompany the financial documents. Supporting documents may be statements, deposit slips, identification, letters, or any document deemed fit to support the financial document. The interface generated by the system allows for upload and remote acceptance of financial documents and supporting documents as a data file. The system may be configured to recognize and read the financial document and the supporting document. The system may validate the financial document. The system may also validate the supporting document. The system may further process the financial documents to complete the interaction. The system may further process the supporting documents.

As used herein, an “entity” may be any institution employing information technology resources and particularly technology infrastructure configured for processing large amounts of data. Typically, the data may be related to products, services, and/or the like offered and/or provided by the entity, customers of the entity, other aspect of the operations of the entity, people who work for the entity, and/or the like. As such, the entity may be an institution, group, association, financial institution, establishment, company, union, authority, merchant, service provider, and/or the like employing information technology resources for processing large amounts of data. In some embodiments, the entity may be an institution, group, association, financial institution, establishment, company, union, authority, merchant, service provider, and/or the like hosting, sponsoring, coordinating, creating, and/or the like events, recognitions, achievements, and/or the like.

As used herein, a “user” may be an individual associated with an entity. As such, in some embodiments, the user may be an individual having past relationships, current relationships or potential future relationships with an entity. In some embodiments, a “user” may be an employee (e.g., an associate, a project manager, a manager, an administrator, an internal operations analyst, and/or the like) of the entity and/or enterprises affiliated with the entity, capable of operating systems described herein. In some embodiments, a “user” may be any individual, another entity, and/or a system who has a relationship with the entity, such as a customer, a prospective customer, and/or the like. In some embodiments, a user may be a system performing one or more tasks described herein. In some embodiments, a user may be a verified authority as described herein.

As used herein, a “user interface” may be any device or software that allows a user to input information, such as commands and/or data, into a device, and/or that allows the device to output information to the user. For example, a user interface may include an application programmer interface (API), a graphical user interface (GUI), and/or an interface to input computer-executable instructions that direct a processing device to carry out functions. The user interface may employ input and/or output devices to input data received from a user and/or output data to a user. Input devices and/or output devices may include a display, API, mouse, keyboard, button, touchpad, touch screen, microphone, speaker, LED, light, joystick, switch, buzzer, bell, and/or other devices for communicating with one or more users.

As used herein, a “resource” may generally refer to objects, products, devices, goods, commodities, services, offers, discounts, currency, cash, cash equivalents, rewards, reward points, benefit rewards, bonus miles, cash back, credits, and/or the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, and/or the like.

As used herein, a “source retainer” may generally refer to an account, a system, and/or the like associated with a user and/or a type of resources, such as software, a checking account, a deposit account, a savings account, a credit account, a rewards account, a rewards points account, a benefit rewards account, a bonus miles account, a cash back account, and/or the like, which may be managed and/or maintained by an entity, such as a financial institution, an electronic resource transfer institution (e.g., a credit card company, a debit card company, a prepaid card company, and/or the like), a credit union, and/or the like.

As used herein, a “distribution” and/or an “allocation” may refer to any transaction, activities, and/or communication between one or more entities, between a user and one or more entities, and/or the like. A resource distribution and/or an allocation of resources may refer to any distribution of resources such as, but not limited to, a payment, processing of funds, purchase of goods or services, a return of goods or services, a payment transaction, a credit transaction, other interactions involving a user's resource or account, and/or the like. In the context of an entity such as a financial institution, a resource distribution and/or an allocation of resources may refer to one or more of a sale of goods and/or services, initiating an automated teller machine (ATM) or online financial session, an account balance inquiry, a rewards transfer, an account money transfer or withdrawal, opening a financial application on a user's computer or mobile device, a user accessing their e-wallet, any other interaction involving the user and/or the user's device that invokes and/or is detectable by the financial institution, and/or the like. In some embodiments, the user may authorize a resource distribution and/or an allocation of resources using a resource distribution instrument (e.g., credit cards, debit cards, checks, digital wallets, currency, loyalty points, and/or the like) and/or resource distribution credentials (e.g., account numbers, resource distribution instrument identifiers, and/or the like). A resource distribution and/or an allocation of resources may include one or more of the following: renting, selling, and/or leasing goods and/or services (e.g., groceries, stamps, tickets, DVDs, vending machine items, and/or the like); making payments to creditors (e.g., paying monthly bills; paying federal, state, and/or local taxes; and/or the like); sending remittances; loading money onto stored value cards (SVCs) and/or prepaid cards; donating to charities; and/or the like. Unless specifically limited by the context, a “resource distribution,” an “allocation of resources,” a “resource transfer,” a “transaction,” a “transaction event,” and/or a “point of transaction event” may refer to any activity between a user, a merchant, an entity, and/or the like. In some embodiments, a resource distribution and/or an allocation of resources may refer to financial transactions involving direct or indirect movement of funds through traditional paper transaction processing systems (e.g., paper check processing) or through electronic transaction processing systems. In this regard, resource distributions and/or allocations of resources may refer to the user initiating a purchase for a product, service, or the like from a merchant. Typical financial resource distribution and/or financial allocations of resources include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, and/or the like. When describing that resource transfers or transactions are evaluated, such descriptions may mean that the transaction has already occurred, is in the process of occurring or being processed, or has yet to be processed/posted by one or more financial institutions.

As used herein, “resource distribution instrument” may refer to an electronic payment vehicle, such as an electronic credit, debit card, and/or the like, associated with a source retainer (e.g., a checking account, a deposit account, a savings account, a credit account, and/or the like). In some embodiments, the resource distribution instrument may not be a “card” and may instead be account identifying information stored electronically in a user device, such as payment credentials and/or tokens and/or aliases associated with a digital wallet, account identifiers stored by a mobile application, and/or the like.

In some embodiments, the term “module” with respect to an apparatus may refer to a hardware component of the apparatus, a software component of the apparatus, and/or a component of the apparatus that includes both hardware and software. In some embodiments, the term “chip” may refer to an integrated circuit, a microprocessor, a system-on-a-chip, a microcontroller, and/or the like that may either be integrated into the external apparatus, may be inserted and/or removed from the external apparatus by a user, and/or the like.

As used herein, an “engine” may refer to core elements of a computer program, part of a computer program that serves as a foundation for a larger piece of software and drives the functionality of the software, and/or the like. An engine may be self-contained but may include externally controllable code that encapsulates powerful logic designed to perform or execute a specific type of function. In one aspect, an engine may be underlying source code that establishes file hierarchy, input and/or output methods, how a part of a computer program interacts and/or communicates with other software and/or hardware, and/or the like. The components of an engine may vary based on the needs of the computer program as part of the larger piece of software. In some embodiments, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, a “component” of an application may include a software package, a service, a resource, a module, and/or the like that includes a set of related functions and/or data. In some embodiments, a component may provide a source capability (e.g., a function, a business function, and/or the like) to an application including the component. In some embodiments, components of an application may communicate with each other via interfaces and may provide information to each other indicative of the services and/or functions that other components may utilize and/or how other components may utilize the services and/or functions. Additionally, or alternatively, components of an application may be substitutable such that a component may replace another component. In some embodiments, components may include objects, collections of objects, and/or the like.

As used herein, “authentication credentials” may be any information that may be used to identify a user. For example, a system may prompt a user to enter authentication information such as a username, a password, a token, a personal identification number (PIN), a passcode, biometric information (e.g., voice authentication, a fingerprint, and/or a retina scan), an answer to a security question, a unique intrinsic user activity, such as making a predefined motion with a user device, and/or the like. The authentication information may be used to authenticate the identity of the user (e.g., determine that the authentication information is associated with an account) and/or determine that the user has authority to access an account or system. In some embodiments, the system may be owned and/or operated by an entity. In such embodiments, the entity may employ additional computer systems, such as authentication servers, to validate and certify resources inputted by a plurality of users within the system. The system may further use authentication servers to certify the identity of users of the system, such that other users may verify the identity of the certified users. In some embodiments, the entity may certify the identity of the users. Furthermore, authentication information and/or permission may be assigned to and/or required from a user, application, computing node, computing cluster, and/or the like to access stored data within at least a portion of the system.

As used herein, an “interaction” may refer to any communication between one or more users, one or more entities or institutions, and/or one or more devices, nodes, clusters, and/or systems within the system environment described herein. For example, an interaction may refer to a transfer of data between devices, an accessing of stored data by one or more nodes of a computing cluster, a transmission of a received task, and/or the like. In some embodiments, an interaction may refer to an entity, a user, a system, and/or a device providing an advertisement, information, data, a user interface, and/or the like to another entity, another user, another system, and/or another device.

As used herein, identifiers such as “first,” “second,” “third,” and/or the like do not indicate a temporal relationship, unless explicitly stated. Such identifiers may modify instances of similar things and may be used to differentiate between each of the instances.

As used herein, a “subset” may refer to one or more from a group. For example, a subset of users from a group of users may be one user from the group of users, multiple users from the group of users, or all of the users from the group of users. As another example, a subset of properties may be one property from the properties, multiple properties from the properties, or all of the properties.

As described herein, a system is provided to generate user device interfaces that enable and/or facilitate the upload, and remote acceptance, of one or more data files. As such, the system can begin when a user requests to transfer funds received from a financial document (e.g., personal check, paycheck, and the like). The request can be made from a mobile device interface of the user. A user interface is then generated to display selectable contribution types (e.g., 401K direct rollover contribution, loan payment contribution, investment account contribution, and the like) for the deposit.

Descriptions of the contribution types, disclaimers, and the like are also provided on the display to inform the user about each selectable contribution type, to inform the user and to meet any regulatory or entity policy requirements of a managing entity that is performing the processes of the system.

The display may then prompt the user to capture one or more images of the financial document. Once the user captures the image(s) of the financial document, the system extracts pertinent document information from the financial document using optical character recognition (OCR). As information is acquired the OCR processes, the system may automatically store the extracted information in an encrypted environment to protect such information from unauthorized disclosure, thereby ensuring a secure and protected environment for processing the information derived from the paper financial documents while in the electronic environment.

The user interface may also display a prompt to request supplemental documentation from the user. The supplemental documentation may include user identification information, documentation related to the payor and/or the user's association with the applicable contribution types, any other information associated with any requirements, thresholds, or conditions associated with the selected contribution type).

The display prompts the user to capture an image of the supplemental document. The system extracts pertinent supplemental document information from the image using OCR. In response to determining that the extracted supplemental document data meets the specific requirements, thresholds, or conditions of the contribution type, the system then transfers the resources associated with the financial document into the appropriate account based on the selected contribution type.

The inventions described herein provide a unique and practical process for enabling users and managing entities to process financial instruments to transfer resources into accounts that have strict qualifications, thresholds, constraints, regulatory requirements, tax requirements, and the like, via a user's personal computing device (e.g., mobile phone) in an efficient and prompt manner, without the need for the user to fill out multiple online forms or applications. Instead, the system allows the user to capture images of relevant transaction or financial documentation (including financial documents like checks from employers that are subscribed to a particular investment or retirement plan with such qualifications, thresholds, constraints, and requirements) and supplemental documentation (including user identification documentation, investment or retirement account application or verification documentation, documentation that includes information relevant to the qualifications, thresholds, constraints, and/or requirements of the investment or retirement account, and the like), and provide such image captures to the system in a manner that enables the system to use optical character recognition processes to extract the relevant information, verify the user, verify the employer or payor, verify permissions associated with the user and/or the user's deposit of resources in to the investment or retirement account, and/or the like.

As mentioned before, as information is acquired the OCR processes, the system may automatically store the extracted information in an encrypted environment to protect such information from unauthorized disclosure, thereby ensuring a secure and protected environment for processing the information derived from the paper financial documents while in the electronic environment. Furthermore, as the information acquired from physical, paper financial documents comes in varied forms and formats (e.g., typed fields, magnetic ink character recognition (MICR) fields, hand-written fields, signature fields, numerical fields, alphabetic fields, alpha-numeric fields, and the like), the system may be configured to convert the extracted data and information from non-standardized formats into uniform, standardized, or at least compatible formats, such that the system is then able to process the requested transfers or other actions in an electronic environment despite the disparate formats of the fields (as they were originally received by the system).

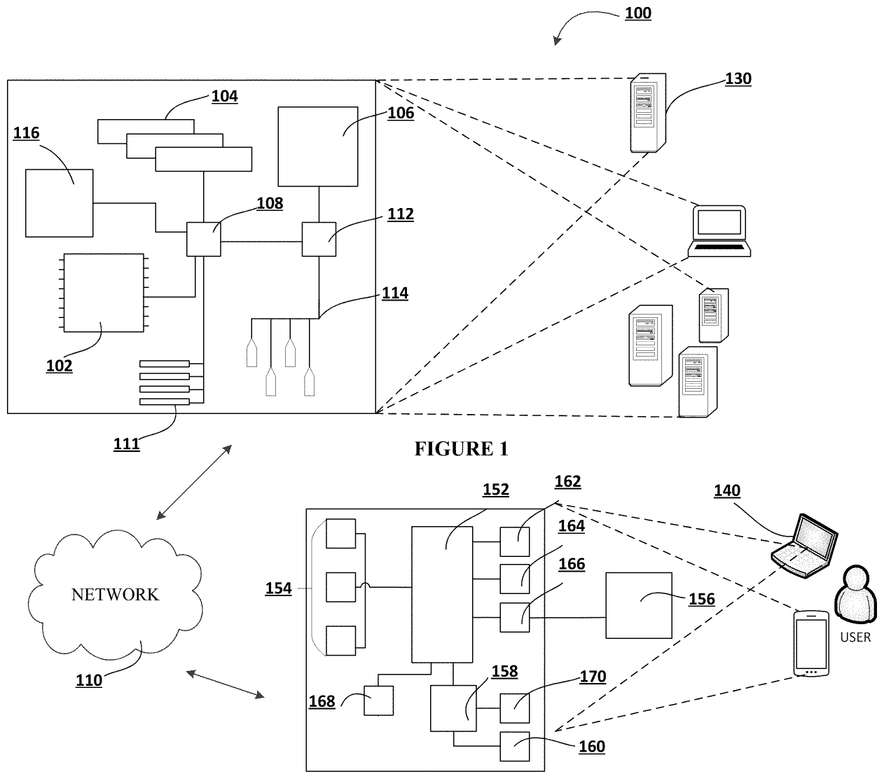

FIG. 1 presents an exemplary block diagram of a system environment 100 for generating an interface for upload and remote acceptance of a data file, in accordance with an embodiment of the invention. FIG. 1 provides a system environment 100 that includes specialized servers and a system communicably linked across a distributive network of nodes required to perform functions of process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device, a non-mobile computing device, and/or the like. The user may be a person who uses the user input system 140 to access, view modify, interact with, and/or the like information, data, images, video, and/or the like. The user may be a person who uses the user input system 140 to initiate, perform, monitor, and/or the like changes and/or modifications to one or more systems, applications, services, and/or the like. The one or more systems, applications, services, and/or the like may be configured to communicate with the system 130, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology.

In some embodiments, the system 130 and the user input system 140 may be used to implement processes described herein, in accordance with an embodiment of the present invention. The system 130 may represent various forms of digital computers, such as laptops, desktops, workstations, personal digital assistants, servers, blade servers, mainframes, and/or the like. The user input system 140 may represent various forms of mobile devices, such as personal digital assistants, cellular telephones, smartphones, smart glasses, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130 may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The memory 104 may store information within the system 130. In one implementation, the memory 104 may be a volatile memory unit or units, such as volatile random-access memory (RAM) having a cache area for the temporary storage of information. In another implementation, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the invention. The user input system 140 may include a processor 152, memory 154, an input/output device such as a display 156, a communication interface 158, and a transceiver 160, among other components, such as one or more image sensors. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140 and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user may provide input to the computer, and/or a pointing device (e.g., a mouse or a trackball) by which the user may provide input to the computer. Other kinds of devices may be used to provide for interaction with a user as well. For example, a response provided to the user may be any form of sensory response (e.g., visual response, auditory response, and/or tactile response). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

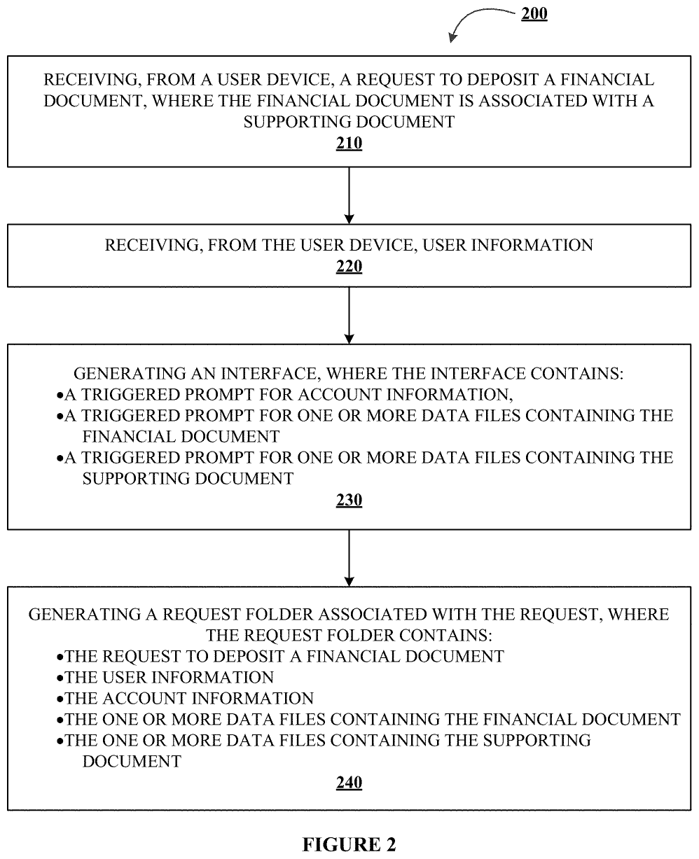

In some embodiments, the system environment may 100 include one or more user input systems and/or one or more systems for generating an interface for upload and remote acceptance of a data file (e.g., similar to the system 130 and/or the user input system 140) associated with an entity (e.g., a business, a merchant, a financial institution, a card management institution, an software and/or hardware development company, a software and/or hardware testing company, and/or the like). For example, a user (e.g., an employee, a customer, and/or the like) may use a user input system (e.g., similar to the user input system 140) to initiate upload and remote acceptance of a data file, and/or the like using one or more systems, applications, services, and/or the like (e.g., similar to the system 130, running a system similar to the system 130, and/or the like) and the user input system may provide information (e.g., event information, user information, and/or the like) to a system for generating an interface for upload and remote acceptance of a data file (e.g., similar to the system 130, running a system similar to the system 130, and/or the like). In some embodiments, the user input system, the interface generating system, and/or the data file generating system associated with the entity may perform one or more of the steps described herein with respect to the process flow described herein with respect to FIG. 2.

FIG. 2 illustrates a process flow 200 for generating an interface for upload and remote acceptance of a data file, in accordance with an embodiment of the invention. In some embodiments, an interface generation system, a managing entity system, and/or the like (e.g., similar to one or more of the systems described herein with respect to FIG. 1) may perform one or more of the steps of process flow 200.

As shown in block 210, the process flow 200 may include receiving, from a user device, a request to deposit a financial document into an account, wherein the account is associated with specific requirements, thresholds, or conditions. The financial document may be associated with a supporting document. In some embodiments, the financial document may be a check, such as a personal check, a business check, a government-issued check, a payroll check, or any other order for a resource or resource(s) deemed suitable for deposit. In some embodiments, the supporting document may be an entity-issued statement, a third-party issued statement, a bill, or a letter. Additionally, or alternatively, the supporting document may be identification documents to identify the user, a payor, or payee of the financial document. The user device may be any mobile communication device such as a cellular telecommunications device (cell phone, mobile phone, smart phone), personal digital assistant (PDA), or other mobile device including but not limited to laptop computers, desktop computers, and tablet computers. As shown in block 210, the process flow may include receiving, from the user device, user information. In some embodiments, the user information may be the device or user location or the IP address of the device. The user information may be any information that can be used to validate the request and/or confirm the identity of the user.

As shown in block 230, the process flow 200 may include generating an interface. In some embodiments, the interface contains a triggered prompt for account information. In some embodiments the interface contains a triggered prompt to request and/or facilitate the image capture of one or more data files containing the financial document. In some embodiments, the interface contains a triggered prompt to request and/or facilitate the image capture of one or more data files containing the supporting document. Additionally, or alternatively, the interface may further include a triggered prompt for an amount. In some embodiments, the interface may further include a triggered prompt for additional account information. Additionally, or alternatively, the interface may include a triggered prompt for additional deposit information. In some embodiments, the additional deposit information comprises a contribution type. In some embodiments, the interface may include additional requests. In some embodiments, the data file(s) may be a PDF file. In some embodiments, the data file(s) may be a text file. Additionally, or alternatively, the data file(s) may be a picture file such as a JPEG or a TIFF file. In some embodiments, the data file(s) may be a video file. Additionally, or alternatively, the data file(s) may be obtained from a camera operatively or communicatively coupled to the user device. In some embodiments, the data file(s) may be obtained from a file storage system operatively or communicatively coupled to the user device.

In order to extract the document information, supplemental document information, metadata, and other data or information from one or more documents or images, optical character recognition (OCR) may be utilized. In this way, optical character recognition may be used to extract the metadata from financial documents, such as text documents and financial record images, such as checks or other financial instruments. The system may lift data off of the document (check, financial document, payment instrument, or other financial record) using OCR. The OCR processes enable the system to convert text and other symbols in the check images to other formats such as text files and/or metadata, which can then be used and incorporated into a variety of applications, documents, and processes. In some embodiments, OCR based algorithms used in the OCR processes incorporate pattern matching techniques. For example, each character in an imaged word, phrase, code, or string of alphanumeric text can be evaluated on a pixel-by-pixel basis and matched to a stored character. Various algorithms may be repeatedly applied to determine the best match between the image and stored characters.

In some embodiments, the account information comprises the type of account. Additionally, or alternatively, the account information comprises the account number. In some embodiments, the type of account is a 401K account, an online benefits account, a retirement or long-term investment account, or the like. In some embodiments, the type of account is a Health Savings Account. In some embodiments, the type of account is a Health Reimbursement Account. Additionally, or alternatively, the type of account may be a savings account. Additionally, or alternatively, the type of account may be a checking account. In some embodiments, the user is requesting to transfer resources received from an entity payor via a financial instrument (e.g., a check), through using a contribution type of a direct rollover into a 401K or similar investment or retirement account.

As shown in block 240, the process flow 200 may include generating a request folder associated with the request. The request folder may contain the account information, the user information, the one or more data files containing the financial document, and the one or more files containing the supporting document.

Process flow 200 may include additional embodiments, such as any single embodiment or any combination of embodiments described below and/or in connection with one or more other processes described elsewhere herein.

In a first embodiment, the process flow 200 may further include the additional step of validating the financial document.

In a second embodiment alone or in combination with the first embodiment, the process flow 200 may further include the additional step of validating the supporting document.

In a third embodiment, alone or in combination with any one of the first through second embodiments, the process flow 200 may further include the additional step of applying an object recognition application. The object recognition application may utilize pattern recognition algorithms to analyze the financial document. In some embodiments, the object recognition application may utilize pattern recognition algorithms to analyze the supporting document.

In a fourth embodiment alone or in combination with any of the first through third embodiments, the system may process the deposit.

Although FIG. 2 shows example blocks of process flow 200, in some embodiments, process flow 200 may include additional blocks, fewer blocks, different blocks, or differently arranged blocks than those depicted in FIG. 2. Additionally, or alternatively, two or more of the blocks of process flow 200 may be performed in parallel.

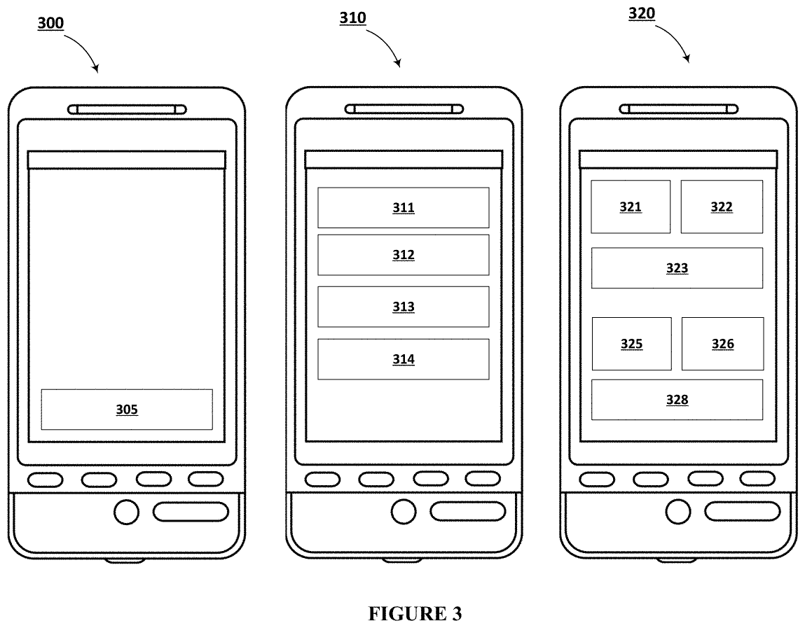

FIG. 3 illustrates an exemplary schematic of the interface for upload and acceptance of a data file. The interface 300 provides the user with an option 305 to request to deposit a financial document. The interface 310 provides triggered prompts 311, 312, 313, 314 for account information, and other information to facilitate the request. The interface 320 provides triggered prompts 321 and 322 for data files containing the financial document, a triggered prompt 323 for information about the financial document, triggered prompts 325 and 326 for data files containing the supporting document, and triggered prompt 328 for information about the supporting document.

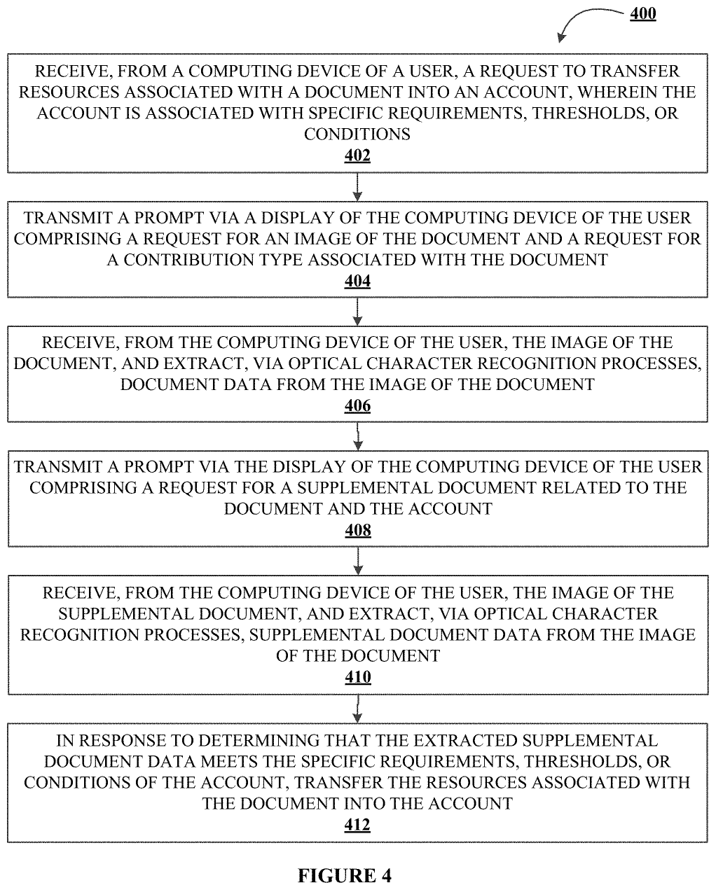

Referring now to FIG. 4, a flowchart is provided to illustrate one embodiment of a process 400 for the generation of an interface for upload and remote acceptance of data files, in accordance with embodiments of the invention. In some embodiments, the process 400 may include block 402, where the system receives, from a computing device of a user, a request to transfer resources associated with a document into an account, wherein the account is associated with specific requirements, thresholds, or conditions.

In some embodiments, the process 400 includes block 404, where the system transmits a prompt via a display of the computing device of the user comprising a request for an image of the document and a request for a contribution type associated with the document.

The prompt comprising the request for the image of the document may, in some embodiments, further cause the computing device of the user to open an image capturing device of the computing device of the user. For example, the system may transmit a prompt to the computing device of the user to cause the camera feature to open (either automatically or upon acceptance of a selectable message or icon presented to the user via the display of the computing device).

The prompt comprising the request for the contribution type associated with the document may, in some embodiments comprise a display of selectable available financial accounts, including the account, into which the resources may be allocated, and information and disclaimers regarding each of the available financial accounts. For example, the available financial accounts and/or contribution types may include a selectable field for a direct rollover of resources from a financial instrument (e.g., physical check) into a 401K or other retirement or investment account. As contributions characterized as direct rollovers into 401K accounts involve specific regulatory, tax, and other requirements, the managing entity of the system may have specific disclaimers, information, descriptions, policies, explanations, and the like that can be presented to the user via the user interface such that the user is able to make informed decisions regarding the transfer of resources associated with the document.

For example, 401K accounts have restrictions on amounts that employees can contribute in a given year and amounts that employees and their employers, in total, can contribute in a given year. There are also special considerations regarding catch-up contributions (including qualification and annual resource limitations) that can adjust whether a user is qualified to deposit certain resources in a 401K or other retirement or investment account or vehicle. As such, these specific types of requirements, thresholds, and conditions may be identified for the account, and stored for later analysis and/or comparison with information received from the user (e.g., via an OCR-processed analysis of images of the document and/or the supplemental document(s) that are generated as part of this system).

Additionally, in some embodiments, the process 400 includes block 406, where the system receives, from the computing device of the user, the image of the document, and extracts, via optical character recognition processes, document data from the image of the document.

The document data may, in some embodiments, comprise one or more of a payor name, a payee name, a payor account number, payor account routing number information, payor entity information associated with the specific requirements, thresholds, or conditions of the account, a document execution date, an amount of resources associated with the document, payee signature information, or payee deposit designations or indications (e.g., hand-written indication of intention to deposit resources of the document into the account). There may be a special designation on the document that indicates that the resources associated with the document may be intended for, approved for, or otherwise available to be transferred as part of a user contribution into a special type of account (including the account described herein), which may be a 401K account, another retirement or investment account, a loan account, a benefits account, or the like.

Furthermore, the system may automatically store the extracted information in an encrypted environment to protect such information from unauthorized disclosure, thereby ensuring a secure and protected environment for processing the information derived from the paper financial documents while in the electronic environment.

The process 400 may also include block 408, where the system transmits a prompt via the display of the computing device of the user comprising a request for a supplemental document related to the document and the account.

The prompt may comprise the request for the image of the supplemental document further causes the computing device of the user to open an image capturing device of the computing device of the user. For example, the system may transmit a prompt to the computing device of the user to cause the camera feature to open (either automatically or upon acceptance of a selectable message or icon presented to the user via the display of the computing device).

Additionally or alternatively, the prompt comprising the request for the image of the supplemental document further includes a textual message comprising a statement of the specific requirements, thresholds, or conditions associated with the account. As such, the user is provided with real-time information about which documentation needs to be imaged and processed for the system to be able to effectuate the transfer of resources into the special account. For example, the textual prompt may include requests or notes requesting or requiring that the supplemental document includes proof, confirmation, verification information, or similar qualifying information that meets the requirements, thresholds, and/or conditions for the account.

In some embodiments, the process 400 includes block 410, where the system receives, from the computing device of the user, the image of the supplemental document, and extracts, via optical character recognition processes, supplemental document data from the image of the document. The system may automatically store the extracted information in an encrypted environment to protect such information from unauthorized disclosure, thereby ensuring a secure and protected environment for processing the information derived from the paper financial documents while in the electronic environment. The system is then set up to compare the information extracted, formatted, and stored from the images of the document and the supplemental document against the requirements, thresholds, and/or conditions for the account to determine whether the system is permitted or otherwise authorized to transfer the resources from the payor's account to the user's account (e.g., as a direct rollover into a 401K account, or any other deposit or attribution to a retirement or investment account, a benefits account, or the like).

Finally, the process 400 may continue to block 412, where the system in response to determining that the extracted supplemental document data meets the specific requirements, thresholds, or conditions of the account, transfer the resources associated with the document into the account.

The inventions described herein provide a unique and practical process for enabling users and managing entities to process financial instruments to transfer resources into accounts that have strict qualifications, thresholds, constraints, regulatory requirements, tax requirements, and the like, via a user's personal computing device (e.g., mobile phone) in an efficient and prompt manner, without the need for the user to fill out multiple online forms or applications. Instead, the system allows the user to capture images of relevant transaction or financial documentation (including financial documents like checks from employers that are subscribed to a particular investment or retirement plan with such qualifications, thresholds, constraints, and requirements) and supplemental documentation (including user identification documentation, investment or retirement account application or verification documentation, documentation that includes information relevant to the qualifications, thresholds, constraints, and/or requirements of the investment or retirement account, and the like), and provide such image captures to the system in a manner that enables the system to use optical character recognition processes to extract the relevant information, verify the user, verify the employer or payor, verify permissions associated with the user and/or the user's deposit of resources in to the investment or retirement account, and/or the like.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

What is claimed is:

1. A system for generation of an interface for upload and remote acceptance of a data file, the system comprising
at least one non-transitory storage device, and
at least one processing device coupled to the at least one non-transitory storage device, wherein the at least one processing device is configured to:
receive, from a computing device of a user, a request to transfer resources associated with a document into an account, wherein the account is associated with specific requirements, thresholds, or conditions;
transmit a prompt via a display of the computing device of the user comprising a request for an image of the document and a request for a contribution type associated with the document;
receive, from the computing device of the user, the image of the document;
extract, via optical character recognition processes, document data from the image of the document;
transmit a prompt via the display of the computing device of the user comprising a request for a supplemental document related to the document and the account;
receive, from the computing device of the user, the image of the supplemental document;
extract, via optical character recognition processes, supplemental document data from the image of the document;
in response to determining that the extracted supplemental document data meets the specific requirements, thresholds, or conditions of the account, transfer the resources associated with the document into the account.

2. The system of claim 1, wherein the prompt comprising the request for the image of the document further causes the computing device of the user to open an image capturing device of the computing device of the user.

3. The system of claim 1, wherein the prompt comprising the request for the contribution type associated with the document comprises a display of selectable available financial accounts, including the account, into which the resources may be allocated, and information and disclaimers regarding each of the available financial accounts.

4. The system of claim 1, wherein the document data comprises a payor name, a payee name, a payor account number, payor account routing number information, payor entity information associated with the specific requirements, thresholds, or conditions of the account, a document execution date, an amount of resources associated with the document, payee signature information, or payee deposit designations or indications that may include a hand-written indication of intention to deposit resources of the document into the account.

5. The system of claim 1, wherein the prompt comprising the request for the image of the supplemental document further causes the computing device of the user to open an image capturing device of the computing device of the user.

6. The system of claim 1, wherein the prompt comprising the request for the image of the supplemental document further includes a textual message comprising a statement of the specific requirements, thresholds, or conditions associated with the account.

7. The system of claim 1, wherein the supplemental document data comprises information associated with the user's eligibility to deposit resources into the account (including user metrics associated with the specific requirements, thresholds, or conditions associated with the account), information associated with the qualification of the resources associated with the document to be deposited into the account, or information associated with the payor's registration with a program associated with the account.

8. A computer program product for generation of an interface for upload and remote acceptance of a data file, the computer program product comprising at least one non-transitory computer readable medium comprising computer readable instructions, the instructions comprising instructions for:
receiving, from a computing device of a user, a request to transfer resources associated with a document into an account, wherein the account is associated with specific requirements, thresholds, or conditions;
transmitting a prompt via a display of the computing device of the user comprising a request for an image of the document and a request for a contribution type associated with the document;
receiving, from the computing device of the user, the image of the document;
extracting, via optical character recognition processes, document data from the image of the document;
transmitting a prompt via the display of the computing device of the user comprising a request for a supplemental document related to the document and the account;
receiving, from the computing device of the user, the image of the supplemental document;
extracting, via optical character recognition processes, supplemental document data from the image of the document;
in response to determining that the extracted supplemental document data meets the specific requirements, thresholds, or conditions of the account, transferring the resources associated with the document into the account.

9. The computer program product of claim 8, wherein the prompt comprising the request for the image of the document further causes the computing device of the user to open an image capturing device of the computing device of the user.

10. The computer program product of claim 8, wherein the prompt comprising the request for the contribution type associated with the document comprises a display of selectable available financial accounts, including the account, into which the resources may be allocated, and information and disclaimers regarding each of the available financial accounts.

11. The computer program product of claim 8, wherein the document data comprises a payor name, a payee name, a payor account number, payor account routing number information, payor entity information associated with the specific requirements, thresholds, or conditions of the account, a document execution date, an amount of resources associated with the document, payee signature information, or payee deposit designations or indications that may include a hand-written indication of intention to deposit resources of the document into the account.

12. The computer program product of claim 8, wherein the prompt comprising the request for the image of the supplemental document further causes the computing device of the user to open an image capturing device of the computing device of the user.

13. The computer program product of claim 8, wherein the prompt comprising the request for the image of the supplemental document further includes a textual message comprising a statement of the specific requirements, thresholds, or conditions associated with the account.

14. The computer program product of claim 8, wherein the supplemental document data comprises information associated with the user's eligibility to deposit resources into the account (including user metrics associated with the specific requirements, thresholds, or conditions associated with the account), information associated with the qualification of the resources associated with the document to be deposited into the account, or information associated with the payor's registration with a program associated with the account.

15. A computer implemented method for generation of an interface for upload and remote acceptance of a data file, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, from a computing device of a user, a request to transfer resources associated with a document into an account, wherein the account is associated with specific requirements, thresholds, or conditions;
transmitting a prompt via a display of the computing device of the user comprising a request for an image of the document and a request for a contribution type associated with the document;
receiving, from the computing device of the user, the image of the document;
extracting, via optical character recognition processes, document data from the image of the document;
transmitting a prompt via the display of the computing device of the user comprising a request for a supplemental document related to the document and the account;
receiving, from the computing device of the user, the image of the supplemental document;
extracting, via optical character recognition processes, supplemental document data from the image of the document;
in response to determining that the extracted supplemental document data meets the specific requirements, thresholds, or conditions of the account, transferring the resources associated with the document into the account.

16. The computer implemented method of claim 15, wherein the prompt comprising the request for the image of the document further causes the computing device of the user to open an image capturing device of the computing device of the user.

17. The computer implemented method of claim 15, wherein the prompt comprising the request for the contribution type associated with the document comprises a display of selectable available financial accounts, including the account, into which the resources may be allocated, and information and disclaimers regarding each of the available financial accounts.

18. The computer implemented method of claim 15, wherein the document data comprises a payor name, a payee name, a payor account number, payor account routing number information, payor entity information associated with the specific requirements, thresholds, or conditions of the account, a document execution date, an amount of resources associated with the document, payee signature information, or payee deposit designations or indications that may include a hand-written indication of intention to deposit resources of the document into the account.

19. The computer implemented method of claim 15, wherein the prompt comprising the request for the image of the supplemental document further causes the computing device of the user to open an image capturing device of the computing device of the user.

20. The computer implemented method of claim 15, wherein the supplemental document data comprises information associated with the user's eligibility to deposit resources into the account (including user metrics associated with the specific requirements, thresholds, or conditions associated with the account), information associated with the qualification of the resources associated with the document to be deposited into the account, or information associated with the payor's registration with a program associated with the account.
